(19) United States
(12) Patent Application Publication
(10) Pub. No.: US 2009/0064273 A1
(43) Pub. Date: Mar. 5, 2009

(54) Methods and systems for secure data entry and maintenance

(75) Inventor: Mark Buer, Gilbert, AZ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/896,425

(22) Filed: Aug. 31, 2007

(51) Int. Cl. H04L 9/00

(52) U.S. Cl. 726/1

(57) ABSTRACT

Methods and systems are provided for the secure entry and maintenance of data entered via a user input device. A computing device includes a secure processor coupled to one or more user devices. The user devices may be peripheral devices coupled to the secure processor via a wired connection such as a USB or PS/2 interface or via a wireless connection such as Bluetooth. A security boundary associated with the secure processor is established using hardware or cryptographic techniques. Input data received from the user device is stored within the security boundary. Additionally, the secure processor is configured to identify the user peripheral device coupled to the secure processor and to determine whether a request received to access the user peripheral device is allowable based on security policies defined for the user peripheral device.

### FIELD OF THE INVENTION

This application relates generally to data communications and more specifically to information security.

### BACKGROUND OF THE INVENTION

Certain types of devices and applications are targets for hackers and other malicious individuals attempting to gain access to sensitive user information. To access these devices and applications, a user enters a password or other forms of sensitive data via a user input device such as a keyboard.

Typical computing devices do not include mechanisms to securely maintain sensitive data entered by a user via a user peripheral device. Therefore, this data is susceptible to attack at the entry interface and at non-secure storage locations within the computing device.

What are therefore needed are methods and systems for the secure entry and maintenance of data entered via a user input device.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an exemplary operating environment for the secure entry and maintenance of user data, according to embodiments of the present invention.

FIG. 2 is an exemplary device for the secure entry and maintenance of user data, according to embodiments of the present invention.

FIG. 3 depicts a flowchart of a method for securely maintaining input data from a user peripheral device in a computing device having a secure processor, according to embodiments of the present invention.

FIG. 4 depicts a flowchart of a method for securely managing user peripheral devices in a computing device having a secure processor, according to embodiments of the present invention.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

The following methods and systems make use of existing non-cryptographic capabilities of smartcards as an additional authentication mechanism.

FIG. 1 is an exemplary operating environment 100 for the secure entry and maintenance of user data, according to embodiments of the present invention. Exemplary operating environment 100 includes a computing device 150, one or more wired user peripheral devices 102, and one or more wireless user peripheral devices 104.

Computing device 150 includes an integrated secure processor 140, a host processor 160, and memory 170. Computing device 150 is any device with a processor including, but not limited to, a personal computer, a laptop, a wireless phone, a personal digital assistant (PDA), or a personal entertainment device.

Secure processor 140 provides the required cryptographic operations to encrypt, decrypt, and/or authenticate data that is sent or received by the secure processor. Secure processor 140 may comprise a processor, memory, dedicated cryptographic hardware, and a user device interface module 144. In addition, secure processor 140 may incorporate other security mechanisms. In an embodiment, secure processor 140 is designed to conform to a security specification relating to, for example, Fully Interactive Partition Splitter (FIPS) or Trusted Platform Module (TPM).

A security boundary associated with secure processor 140 may be established, for example, using hardware and/or cryptographic techniques. Hardware techniques for providing a security boundary may include, for example, placing components within a single integrated circuit. In addition, one or more integrated circuits may be protected by a physical structure using tamper evident and/or tamper resistant techniques such as epoxy encapsulation. Encryption techniques for establishing a security boundary may include, for example, encrypting sensitive information before it leaves secure processor 140. For this purpose, secure processor 140 may use one or more cryptographic processors and store the associated encryption/decryption keys in a secure memory internal to secure processor 140.

User device interface module 144 is configured to maintain sensitive information entered via a user peripheral device within the security boundary associated with the secure processor 140. In an embodiment, user device interface module 144 is also configured to control one or more user peripheral devices based on defined policies.

In some embodiments, user device interface module 144 resides within the security boundary associated with secure processor 140. In these embodiments, information received from user peripheral device may be securely maintained within secure processor 140. For example, a password entered via a keyboard may be stored in a memory within the security boundary. In embodiments, secure processor 140 is configured to perform certain processing on the data stored within the security boundary. As a result, certain data entered via a user peripheral device never leaves the security boundary associated with secure processor 140. Thus, the input data remains secured, even if the computing device is compromised.

User interface module 144 is also configured to communicate with one or more user peripheral devices 102, 104. In an embodiment, user interface module 144 communicates with a user peripheral device 102 via a wired interface such as a universal serial bus (USB) interface or PS/2 interface. User peripheral device 102 may be any type of device including but not limited to a keyboard or an external drive.

In an additional or alternative embodiment, user interface module 144 communicates with one or more peripheral device 104 via wireless protocol such as Bluetooth. For example, peripheral devices 104 may be part of a Wireless Personal Area Network (WPAN). Peripheral device 104 may be any type of wireless user device including, but not limited to, a wireless keyboard. As would be appreciated by persons of skill in the art, other types of peripheral devices could be supported by system 100.

Host processor 160 is configured to execute one or more applications 155. An application 155 requests data from one or more of the user peripheral devices coupled to secure processor 140. User device interface module 144 is configured to intercept data entered via the user peripheral devices and to forward only non-secure data to the host processor 160. Application 155 may also request certain processing operations be performed on data stored within the security boundary associated with secure processor 140.

Memory 170 stores one or more security policies associated with user peripheral devices 102, 104. In an embodiment, a security policy may define rules for operations associated with a user peripheral device. For example, a security policy for an external USB drive may specify that computing device 150 can only read data from the USB drive-writing data from the computing device 150 to the external USB drive is forbidden. In a further example, the security policy for an external USB drive may specify that data can only be written to the external USB drive in encrypted form.

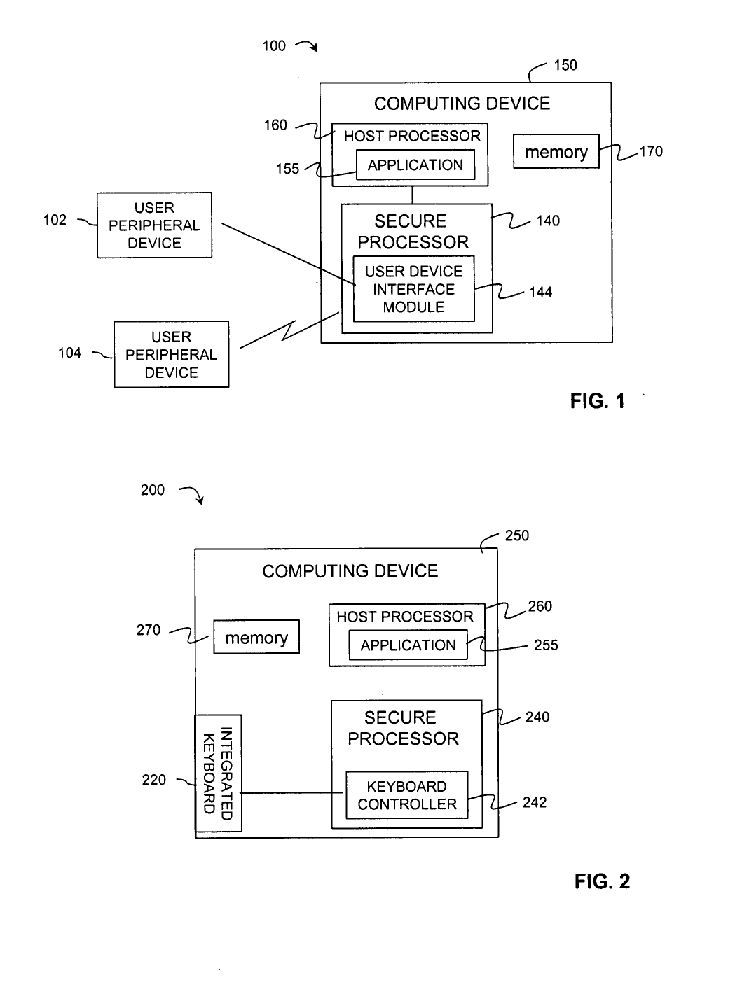

FIG. 2 is an exemplary device 200 for the secure entry and maintenance of user data, according to embodiments of the present invention. Exemplary device 200 includes a secure processor 240, a host processor 260, an integrated keyboard 220, and a memory.

Secure processor 240 includes a keyboard controller 242. Keyboard controller 242 is configured to maintain sensitive information entered via the integrated keyboard 220 within the security boundary associated with the secure processor 240. In some embodiments, keyboard controller 242 resides within the security boundary associated with secure processor 240.

Host processor 260 is configured to execute one or more applications 255. An application 255 requests data from the integrated keyboard 220 coupled to secure processor 240. Keyboard controller 242 is configured to intercept data entered via the integrated keyboard 220 and to forward only non-secure data to the host processor 260. Application 255 may also request certain processing operations be performed on data stored within the security boundary associated with secure processor 240.

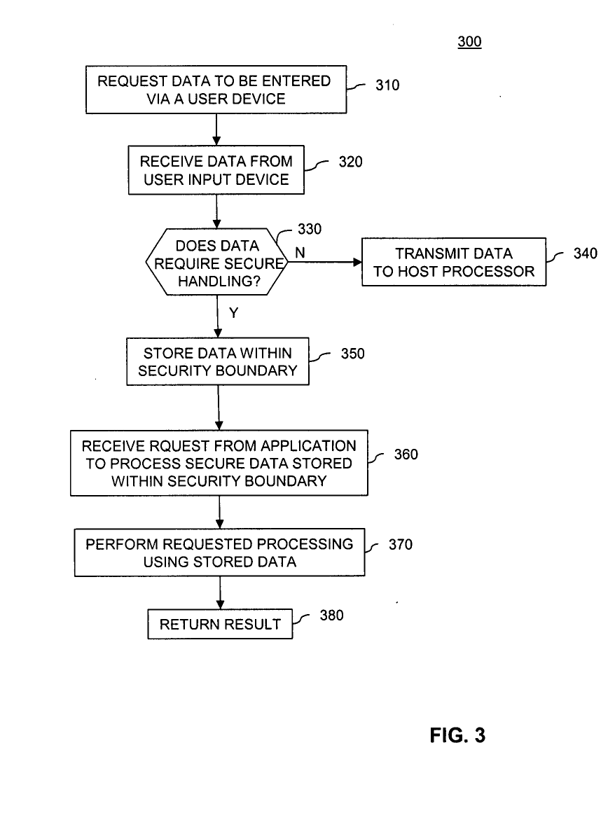

FIG. 3 depicts a flowchart 300 of a method for securely maintaining input data from a user peripheral device in a computing device having a secure processor, according to embodiments of the present invention. Flowchart 300 is described with continued reference to the exemplary embodiments depicted in FIGS. 1 and 2. However, flowchart 300 is not limited to those embodiments. Note that some of the steps in flowchart 300 do not necessarily have to occur in the order shown.

In step 310, an application requests input data to be entered via a user input device (e.g., a keyboard) coupled to the secure processor. In an embodiment, the user input device is a user peripheral device coupled to the secure processor via a USB connection, a PS/2 connection, or a wireless connection (e.g., a Bluetooth connection). In an alternative embodiment, the user input device is a keyboard integrated into the computing device.

In step 320, the secure processor receives data from the user input device. For example, secure processor may intercept data input via the user input device.

In step 330, a determination is made whether the received data requires secure handling. If secure handling is required, operation proceeds to step 340. If secure handling is not required, operation proceeds to step 350. Certain types of data entered by a user are highly sensitive. For example, device or system passwords must be handled in a highly secure manner.

In step 340, the non-sensitive data is forwarded to the host processor.

In step 350, data identified as requiring secure handling is stored within the security boundary of the secure processor. This data is not exposed to the non-secure portions of the computing device.

In step 360, a request is received from an application for processing of a set of secure data stored within the security boundary. For example, an application may request that the secure processor verify a password received from a user device. Because the password does not leave the security boundary of the secure processor, the password verification process occurs within the secure processor.

In step 370, the request processing is performed using the required stored data.

In step 380, a result is returned to the requesting application.

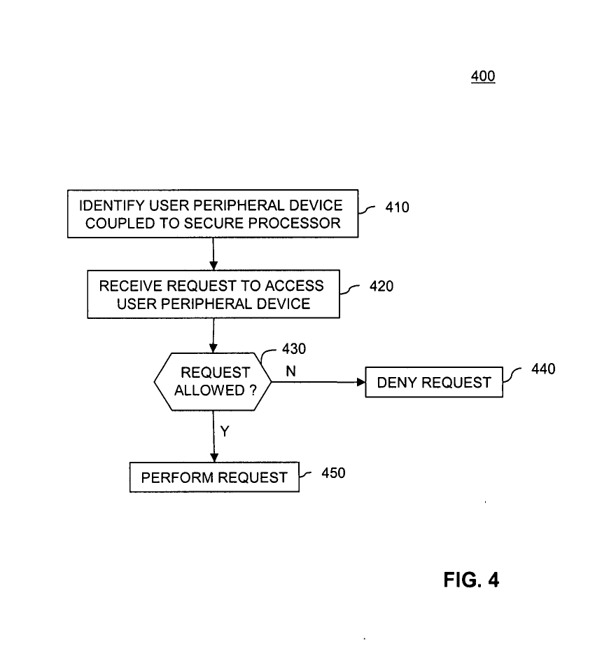

FIG. 4 depicts a flowchart 400 of a method for securely managing user peripheral devices in a computing device having a secure processor, according to embodiments of the present invention. Flowchart 400 is described with continued reference to the exemplary embodiments depicted in FIGS. 1 and 2. However, flowchart 400 is not limited to those embodiments. Note that some of the steps in flowchart 400 do not necessarily have to occur in the order shown.

In step 410, the user peripheral device coupled to the secure processor is identified. In an embodiment, the secure processor identifies the type of device (e.g., keyboard, external driver) and the connection mechanism (e.g., USB, PS/2, Bluetooth). For example, the secure processor may identify that a keyboard or an external drive has been coupled to the secure processor via a USB connection.

In step 420, the secure processor receives a request to access the user peripheral device. An access request may include a request to perform an operation associated with the user peripheral devices. Example access requests include reading data from the user peripheral device or writing data to the user peripheral device.

In step 430, a determination is made whether the access request is allowed. During step 430, the secure processor accesses security policies defined for the user peripheral device. The secure processor determines whether the request is allowed based on the policy. If the access request is not allowed, operation proceeds to step 440. If the access request is allowed, operation proceeds to step 450.

In step 440, the request is denied. An indication of the denial is communicated to the requesting application.

In step 450, the request is performed according to the parameters of the security policy.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for securely maintaining input data from a user peripheral device in a computing device having a secure processor, comprising:
(a) receiving the input data from the user peripheral device coupled to the secure processor;
(b) storing the input data within a security boundary associated with the secure processor if the input data is determined to require secure handling; and
(c) transmitting the input data to a host processor if the input data is determined not to require secure handling.

2. The method of claim 1, further comprising:
prior to step (a),
identifying a request from an application executing on the host processor for the input data to be entered via the user peripheral device.

3. The method of claim 1, wherein step (a) comprises:
(a) receiving the input data from a user peripheral device coupled to the secure processor via a universal serial bus (USB) connection.

4. The method of claim 3, wherein step (a) comprises:
(a) receiving the input data from a keyboard coupled to the secure processor via the USB connection.

5. The method of claim 1, wherein step (a) comprises:
(a) receiving the input data from a user peripheral device coupled to the secure processor via a PS/2 connection.

6. The method of claim 5, wherein step (a) comprises:
(a) receiving the input data from a keyboard coupled to the secure processor via the PS/2 connection.

7. The method of claim 1, wherein step (a) comprises:
(a) receiving the input data from a user peripheral device coupled to the secure processor via a wireless connection.

8. The method of claim 7, wherein step (a) comprises:
(a) receiving the input data from a keyboard coupled to the secure processor via a Bluetooth connection.

9. The method of claim 1, further comprising:
(d) receiving a request from an application to process a set of secure input data stored within the security boundary of the secure processor;
(e) performing the requested processing using the set of secure input data; and
(f) returning a result to the application.

10. The method of claim 1, further comprising:
(a) identifying a second user peripheral device coupled to the secure processor;
(b) receiving a request to access the second user peripheral device; and
(c) determining whether the request is allowable based on a security policy associated with the second user peripheral device.

11. A method for securely maintaining input data from an integrated keyboard in a computing device having a secure processor, comprising:
(a) receiving the input data from the keyboard coupled to the secure processor;
(b) storing the input data within a security boundary of the secure processor if the input data is determined to require secure handling; and
(c) transmitting the input data to a host processor if the input data is determined not to require secure handling.

12. The method of claim 11, further comprising:
(d) receiving a request from an application to process a set of secure input data stored within the security boundary of the secure processor;
(e) performing the requested processing using the set of secure input data; and
(f) returning a result to the application.

13. A system for securely maintaining input data from a user peripheral device in a computing device having a secure processor, comprising:
a host processor;
a secure processor including a user device interface module; and
a user peripheral device coupled to the secure processor,
wherein the secure processor is configured to receive the input data from the user peripheral device and store the input data within a security boundary associated with the secure processor if the input data is determined to require secure handling.

14. The system of claim 13, wherein the user peripheral device is a keyboard.

15. The system of claim 14, wherein the keyboard is coupled to the secure processor via a universal serial bus connection.

16. The system of claim 14, wherein the keyboard is coupled to the secure processor via a PS/2 connection.

17. The system of claim 14, wherein the keyboard is coupled to the secure processor via a wireless connection.

18. The system of claim 13, wherein the user device interface module is further configured to receive a request from an application to process a set of secure input data stored within the security boundary of the secure processor, and to perform the requested processing using the set of secure input data.

19. The system of claim 13, wherein the user device interface module is further configured to identify a second user peripheral device coupled to the secure processor, receive a request to access the user peripheral device, and determine whether the request is allowable based on a security policy associated with the second peripheral device.

20. A system for securely maintaining input data from an integrated keyboard in a computing device having a secure processor, comprising:
a host processor; and
a secure processor including a keyboard controller, wherein the integrated keyboard is coupled to the keyboard controller of the secure processor;
wherein the secure processor is configured to receive the input data from the integrated keyboard and to store the input data within a security boundary associated with the secure processor if the input data is determined to require secure handling.
